(19) United States
(12) Patent Application Publication
(10) Pub. No.: US 2025/0061584 A1
(43) Pub. Date: Feb. 20, 2025

(54) Geodetic Motion Compensated Integration (GMCI) Target Enhancement Filters

(71) Applicant: THE BOEING COMPANY, Arlington, VA (US)

(72) Inventor: John C. RYAN, Yorba Linda, CA (US)

(21) Appl. No.: 18/449,634

(22) Filed: Aug. 14, 2023

(51) Int. Cl. G06T 7/20; G06T 5/30

(52) U.S. Cl. CPC G06T 7/20; G06T 5/30; G06T 2207/20036

(57) ABSTRACT

The present disclosure provides systems and techniques for image-based target detection and tracking. An example technique includes obtaining a geodetic motion-compensated integrated (GMCI) output image of a target. An approximation to a matched filter is generated, based on information associated with the target. An enhanced image is generated based at least in part on the approximation and the GMCI output image. The target is detected and tracked using the enhanced image.

### STATEMENT OF GOVERNMENT INTEREST

This invention was made with Government support under (to be provided) awarded by the Department of Defense. The Government has certain rights in this invention.

### FIELD

Aspects of the present disclosure generally relate to image-based target detection and tracking, and more specifically, to techniques for enhancing detection and tracking of targets in motion compensated integrated images.

### BACKGROUND

Techniques to identify and track targets using non-resolved image data include linear filtering, match filtering, “track-before-detection” techniques, and geodetic motion compensated integration (GMCI) detection. Linear filtering is used to smooth images to reduce noise or “clutter” in the images. Match filtering is used to reduce noise or “clutter” in the images. Match filtering is used to compare potential targets detected in a series of images to reduce false detections. Track-before-detection techniques are used to track potential targets and may enable detection of targets with relatively weak signals against a cluttered background (e.g., targets having a low contrast-to-noise ratio (CNR) in the images). GMCI detection involves mapping successive images of a moving target over a cluttered background to a pixel space to reduce the intensity of the background clutter relative to that of the target.

### SUMMARY

One embodiment of the present disclosure is a computer-implemented method. The computer-implemented method includes obtaining a geodetic motion-compensated integrated (GMCI) output image of a target. The computer-implemented method also includes generating an approximation to a matched filter, based on information associated with the target. The computer-implemented method also includes generating an enhanced image, based at least in part on the approximation and the GMCI output image. The computer-implemented method further includes detecting and tracking the target using the enhanced image.

Another embodiment of the present disclosure is a system. The system includes a memory comprising executable instructions and a processor in data communication with the memory. The processor is configured to execute the executable instructions to perform an operation. The operation includes obtaining a geodetic motion-compensated integrated (GMCI) output image of a target. The operation also includes generating an approximation to a matched filter, based on information associated with the target. The operation also includes generating an enhanced image, based at least in part on the approximation and the GMCI output image. The operation further includes detecting and tracking the target using the enhanced image.

Another embodiment of the present disclosure is a computer-readable storage medium. The computer-readable storage medium includes computer-readable program code embodied therewith for performing an operation. The operation includes obtaining a geodetic motion-compensated integrated (GMCI) output image of a target. The operation also includes generating an approximation to a matched filter, based on information associated with the target. The operation also includes generating an enhanced image, based at least in part on the approximation and the GMCI output image. The operation further includes detecting and tracking the target using the enhanced image.

### BRIEF DESCRIPTION OF THE DRAWINGS

So that the manner in which the above recited features can be understood in detail, a more particular description, briefly summarized above, may be had by reference to example aspects, some of which are illustrated in the appended drawings.

FIG. 1 illustrates an example image-based detection and tracking system, according to certain aspects of the present disclosure.

FIG. 2 depicts an example GMCI output image, according to certain aspects of the present disclosure.

FIG. 3 depicts an example GMCI filter response and a matched filter response, according to certain aspects of the present disclosure.

FIG. 4 depicts an example bivariate normal function and an example gradient function, according to certain aspects of the present disclosure.

FIG. 5 is a flowchart of a method for performing image-based target detection and tracking, according to certain aspects of the present disclosure.

### DETAILED DESCRIPTION

Aspects of the present disclosure provide systems and techniques for enhancing image-based target detection and tracking. While certain techniques (e.g., GMCI detection) can be used to detect and track targets that otherwise would be undetectable in the presence of clutter, it can still be difficult with such techniques to accurately detect and track targets in the presence of high amounts of residual background clutter.

In certain aspects described herein, an image-based target system applies one or more enhancement filters to a motion-compensated integrated image to increase the signal-to-noise ratio (SNR) of a target in the motion-compensated integrated image. Increasing the SNR in this manner can significantly improve the detection and tracking of targets in motion-compensated integrated images, such as GMCI output images.

As used herein, a hyphenated form of a reference numeral refers to a specific instance of an element and the un-hyphenated form of the reference numeral refers to the collective element. Thus, for example, device “12-1” refers to an instance of a device class, which may be referred to collectively as devices “12” and any one of which may be referred to generically as a device “12”.

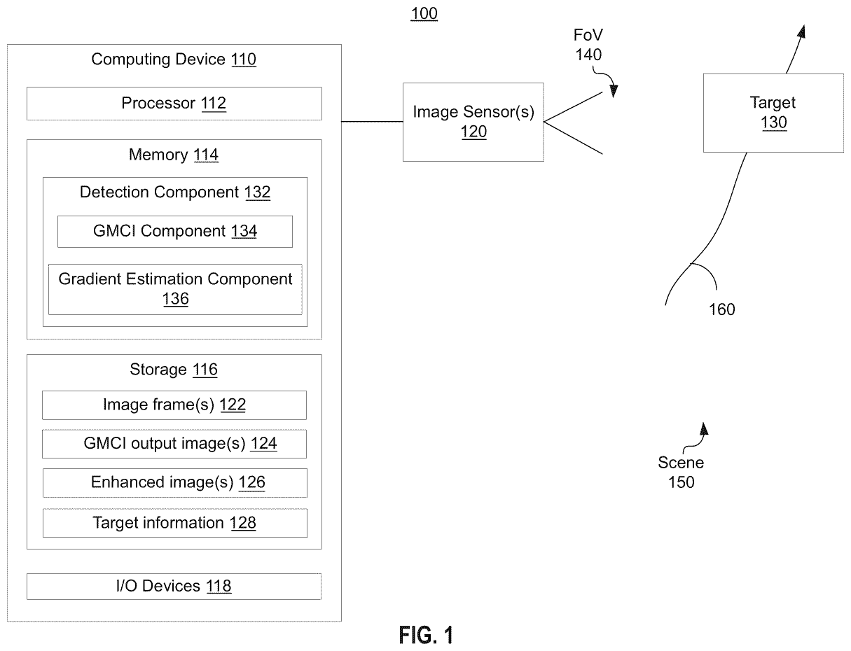

FIG. 1 illustrates an example image-based detection and tracking system 100, according to certain aspects of the present disclosure. The image-based detection and tracking system 100 includes a computing device 110 that is coupled to an image sensor(s) 120. The computing device 110 is configured to perform image processing to track a target 130 in a field of view 140 of the image sensor(s) 120. For example, in certain aspects, the computing device 110 and the image sensor(s) 120 are mounted in a satellite, aircraft, or watercraft, as illustrative, non-limiting examples. In certain aspects, the computing device 110 and the image sensor(s) 120 are implemented at a stationary structure, such as an air traffic control tower, as an illustrative, non-limiting example.

The computing device 110 and the image sensor(s) 120 may be interconnected via one or more networks to enable data communications. For example, the computing device 110 may be coupled to the image sensor(s) 120 via one or more wireless networks, one or more wireline networks, or any combination thereof. The computing device 110 and the image sensor(s) 120 may be co-located or geographically distributed from each other.

The computing device 110 is representative of a variety of computing devices or systems, including a laptop computer, a mobile computer (e.g., a tablet or a smartphone), a server computer, a desktop computer, or an embedded processor such as a field programmable gate array (FPGA), as illustrative, non-limiting examples. The computing device 110 includes a processor 112, a memory 114, storage 116, and one or more input/output (I/O) devices 118. The processor 112 is any electronic circuitry, including, but not limited to one or a combination of microprocessors, microcontrollers, application specific integrated circuits (ASIC), application specific instruction set processors (ASIPs), field programmable gate arrays (FPGAs), and/or state machines, that communicatively couples to memory 114 and controls the operation of the computing device 110, the image sensor(s) 120, or a combination thereof. The processor 112 may be 8-bit, 16-bit, 32-bit, 64-bit or of any other suitable architecture. The processor 112 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

The processor 112 may include other hardware that operates software to control and process information. The processor 112 executes software stored on the memory 114 to perform any of the functions described herein. The processor 112 controls the operation and administration of the computing device 110 by processing information (e.g., information received from the processor 112, memory 114, storage 116, I/O devices 118, image sensor(s) 120, or a combination thereof). The processor 112 is not limited to a single processing device and may encompass multiple processing devices.

The memory 114 may store, either permanently or temporarily, data, operational software, or other information for the processor 112. The memory 114 may include any one or a combination of volatile or non-volatile local or remote devices suitable for storing information. For example, the memory 114 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 114, storage 116, a disk, a CD, or a flash drive. In particular aspects, the software may include an application executable by the processor 112 to perform one or more of the functions described herein. Here, the memory 114 includes a detection component 132, which is generally configured to perform image-based target detection and tracking. The detection component 132 may include hardware, software, or combinations thereof. The detection component 132 includes a GMCI component 134 and a gradient estimation component 136, which are described in greater detail herein.

The storage 116 may be a disk drive or flash storage device. Although shown as a single unit, the storage 116 may be a combination of fixed and/or removable storage devices, such as fixed disc drives, removable memory cards, optical storage, network attached storage (NAS), or a storage area-network (SAN). Storage 116 includes one or more image frames 122, one or more GMCI output images 124, one or more enhanced images 126, and target information 128, which are described in greater detail herein. The I/O devices 118 may include, but are not limited to, one or more of a keypad, a keyboard, a touch-sensitive display screen, a liquid crystal display (LCD) screen, a microphone, a speaker, a communication port, one or more high speed data ports and data links, or any combination thereof.

The image sensor(s) 120 is representative of different types of image sensors, including charge-coupled devices (CCDs), focal plan arrays (FPAs), and complementary metal-oxide-semiconductor (CMOS) and gallium-arsenide (GaAs) based devices, as illustrative, non-limiting examples. The image sensor(s) 120 can capture multiple image frames of a sequence of image frames 122 received from the image sensor(s) 120, such as from video captured by the image sensor(s) 120. Image frames of the sequence of image frames 122 may include background features (e.g., terrain) and a target(s) 130 moving through a scene 150. In an example where the image sensor(s) 120 is aboard an aircraft or satellite, the scene 150 may include a background of geographical features and the target(s) 130 may include an aircraft, watercraft, or land vehicle. The motion of the target(s) 130 relative to the scene 150 is indicated by a movement path 160. Note, in certain aspects, the techniques described herein for image-based target detection and tracking can also be applied to radio and acoustically based images, such as, but not limited to, images formed from synthetic aperture radar (SAR) and synthetic aperture sonar (SAS).

As noted, the computing device 110 may perform image-based target detection and tracking with the detection component 132. The detection component 132 may use motion-compensated integration to reduce or remove background clutter to enable tracking of “dim” (e.g., low-contrast) targets. For example, the detection component 132 includes a GMCI component 134, which is generally configured to map successive images of a moving target (e.g., target 130) over a cluttered background (e.g., scene 150) to a pixel space in order to reduce the intensity of the background clutter relative to that of the target.

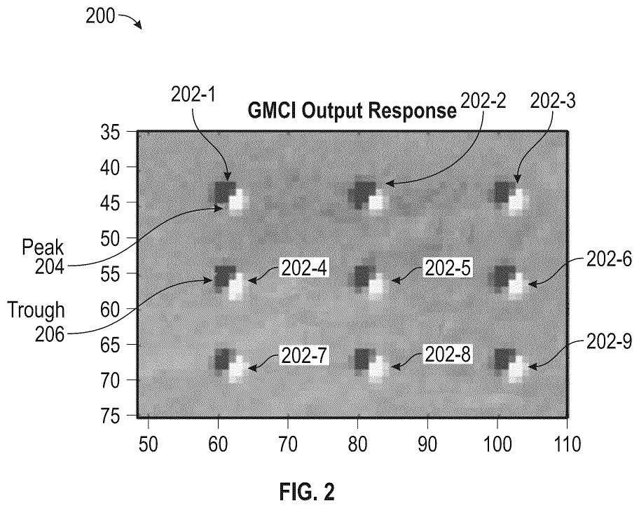

The GMCI component 134 operates on a sequence of images, \vec{I}=(I₁, I₂, . . . , I_{K},), to generate an output image, F. The output image, F, may also be referred to herein as GMCI output image(s) 124. The GMCI component 134 generates the output image F according to Equation (1):

$$F = GMCI ( \vec{I} ) \qquad ( 1 )$$

where \vec{I}=(I₁, I₂, . . . , I_{K},). For a point target, the GMCI component 134 may generate a response characteristic that is a function of the resolution of the image sensor 120, the heading of the target 130, and the speed of the target 130. An example GMCI output image 200 (e.g., output image F) for a formation of nine synthetically generated targets 202 is illustrated in FIG. 2. The GMCI output image 200 is a reference example of the GMCI output image 124.

Note, in the example GMCI output image 200, each target 202 may be travelling at the same speed with the same heading (e.g., southeast). However, in other examples, one or more of the targets 202 may be travelling at different speeds and/or with different headings. As shown in the GMCI output image 200, each target 202 1-9 generates a peak intensity response 204 and a minimum (or trough) intensity response 206 associated with the target's apparent position in the image. The peak intensity response 204 and minimum intensity response 206 that is generated for each target 202 may be due to the differencing operation inherent in the motion-compensated integration performed by the GMCI component 134. More details regarding the use of motion-compensated integration to generate GMCI output images of a target can be found in U.S. Pat. No. 11,195,286 B2, which is incorporated by reference herein in its entirety for all purposes.

In certain GMCI applications, targets can be detected by noting the occurrences of the peak responses above a threshold level using methods such as a constant false alarm rate (CFAR) detector, detect-before-track, maximum aposteriori probability detectors, and maximum likelihood detectors, as illustrative examples. However, using such approaches may ignore information contained in the minimum intensity responses. To address this, certain aspects described herein provide techniques for more efficiently using target information present in a GMCI output image in order to enhance the detection of targets. More specifically, aspects provide techniques for combining target information contained in both the peak intensity response and minimum intensity response via a matched filter in order to improve the detection probability of the target.

In certain aspects, applying a matched filter to a GMCI response may initially involve representing the target GMCI response, F(x,y) (e.g., GMCI output image 200), as two oppositely signed bi-variate normal distributions according to Equations (2), (3), (4), and (5):

$$F ( x , y ) = BVN ( x , y , \vec{μ} , σ ) - BVN ( x , y , - \vec{μ} , σ ) \\ where \qquad ( 2 )$$

$$BVN ( x , y ) = \frac{1}{2 π {σ}^{2}} ( {e}^{- {( x - {μ}_{x} )}^{2} / 2 {σ}^{2}} + {e}^{- {( y - {μ}_{y} )}^{2} / 2 {σ}^{2}} ) \\ where \qquad ( 3 )$$

$$\vec{μ} = [ {μ}_{x} , {μ}_{y} ] = \frac{1}{2} Δ μ [ cos θ , sin θ ] \qquad ( 4 )$$

$$θ = a tan 2 ( {V}_{y} , {V}_{x} ) \qquad ( 5 )$$

where Vₓ and V_{y} denote the target's motion in the GMCI output image, Δμ is the separation of the peak and minimum intensity responses in the GMCI output image, and θ is the target heading. The variance term, a, may depend on a point spread function and integration time of the image sensor and may be predetermined or known a priori. It is noted that the representation of the target response as a differential bivariate normal distribution is for illustration purposes. The techniques described herein are not limited to this particular target description.

An optimal filter has knowledge of the target's velocity (e.g., speed and heading) and the point spread function. Such a filter has a response, H_{O}, given by Equation (6):

$${H}_{O} ( x , y ) = BVN ( x , y , \vec{μ} , σ ) - BVN ( x , y , - \vec{μ} , σ ) \qquad ( 6 )$$

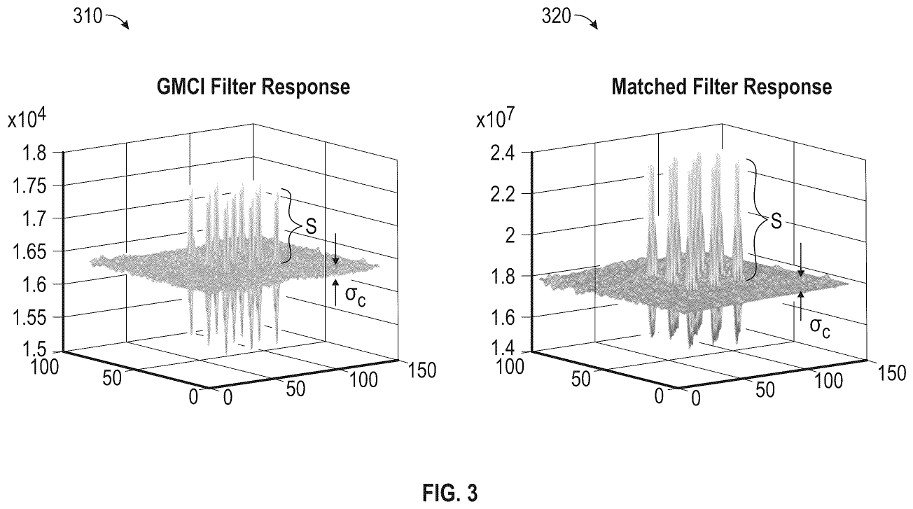

FIG. 3 illustrates an example GMCI response 310 and a matched filter response 320, according to certain aspects of the present disclosure. The GMCI response 310 is the response, F, of the GMCI process (e.g., output of the GMCI component 134) to the target array (e.g., targets 202 1-9) illustrated in FIG. 2. The matched filter response 320 is the response, G, of a matched filter applied to the GMCI response 310, where G=H₀(F). In FIG. 3, the middle response of the target array illustrated in FIG. 2 was used to approximate the optimal matched filter kernel, H_{O}. As shown in this example, the target signal to noise ratio (e.g., S/σ_{C}) is improved approximately 74% relative to the baseline GMCI response in the GMCI response 310.

In certain cases, however, the computing device 110 may lack sufficient target information 128 to implement an optimal matched filter. For example, the computing device 110 may lack knowledge of the image sensor's configuration or parameters, the target's heading, the target's speed, or a combination thereof. In such cases, aspects described herein provide techniques for approximating a matched filter and applying the approximation to a GMCI response in order to enhance target detection. For example, the detection component 132 includes a gradient estimation component 136, which is generally configured to approximate a matched filter to the GMCI target response in the image, using estimated or a priori target information 128.

For certain types of target and clutter, the mean component, Δμ, of the matched filter can be approximated using the following Equation (7):

$$Δ μ = min \{ \frac{1}{2} \sqrt{{V}_{x}^{2} + {V}_{y}^{2}} , 2 \} \qquad ( 7 )$$

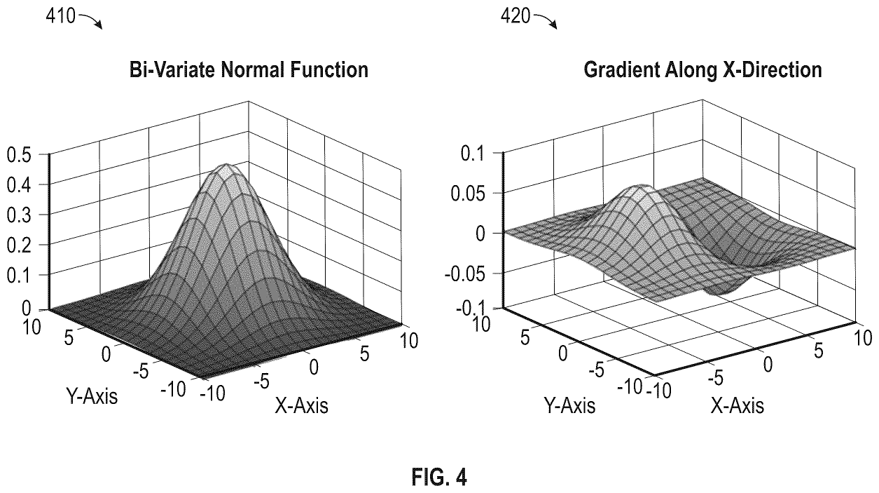

Such a filter, however, may still rely on prior knowledge of the target's velocity components in the image space. To relax these a priori requirements, the computing device 110 can use the gradient estimation component 136 to approximate the GMCI response as the output of a gradient filter, since the gradient of a bivariate normal function is qualitatively similar to the GMCI response, as shown in FIG. 4. In particular, the gradient function shown in graph 420 is qualitatively similar to the GMCI response in graph 410 of a target traveling in the −X direction.

Given this similarity, in certain aspects, the computing device 110 (via the gradient estimation component 136) can approximate the matched filter kernel, H, using a direction-aided gradient filter (DAGF). The DAGF can be represented using the following Equation (8):

$$H ( x , y ; θ ) \approx {G}_{x} cos ( θ ) + {G}_{y} sin ( θ ) \qquad ( 8 )$$

where

$${G}_{x} = \frac{\partial F}{\partial x} , {G}_{y} = \frac{\partial F}{\partial y} ,$$

and F is the GMCI response. In Equation (8), the target heading, θ, is known a priori or is estimated. The DAGF may be useful in tracking applications where a target is intermittently detected or where the target has been lost and has to be reacquired. For example, the computing device 110 may have a reliable estimate of the target heading in such applications.

Additionally, when using a DAGF to approximate a matched filter, the computing device 110 may assume that the target's speed satisfies a predetermined set of conditions (e.g., the target's speed is above a predefined minimum speed and is less than or equal to a predefined maximum speed). Stated differently, the separation between the target's peak and minimum responses may be within predefined limits. For targets moving at higher speeds (e.g., above a predefined maximum speed), the computing device 110 can apply the DAGF to a decimated image of the GMCI response. The decimated image may be generated based on downsampling the GMCI response 124. Alternatively, the input images 122 to the GMCI function may be decimated, and/or the GMCI integration interval may be reduced to decrease the separation between the peak and trough responses on the GMCI output image, F. Correspondingly, for targets below a given speed, the GMCI integration interval may be increased to generate the requisite separation between the target peak and trough responses on the GMCI output image.

In certain aspects, if the computing device 110 determines that no prior target information is known or available, then the computing device 110 can use the local gradient to estimate the target's heading, θ, according to Equation (9), assuming the target is moving within the appropriate speed range:

$$\hat{θ} = {tan}^{- 1} ( \frac{{G}_{Y}}{{G}_{X}} ) \qquad ( 9 )$$

where G_{X} is the gradient of F along the x direction and G_{y} is the gradient of F along the y direction.

In certain aspects, the computing device 110 (via the gradient estimation component 136) can use a gradient magnitude filter (GMF) in Equation (10) to approximate a matched filter:

$$H ( x , y ) = {( {G}_{x}^{2} + {G}_{y}^{2} )}^{1 / 2} \qquad ( 10 )$$

The GMF is a special case of a general class of gradient magnitude filters, H(x,y)=∥∇F∥^{P}. Here any convenient power, P, may be chosen for the given application. The GMF in Equation (10) may be useful for initial target acquisition, as no prior target information is required. The processor may also implement the GMF with any suitable magnitude approximation function.

As with the DAGF approximation, when using a GMF to approximate a matched filter, the computing device 110 may assume that the target's speed satisfies a predetermined set of conditions (e.g., the target's speed is above a predefined minimum speed and is less than or equal to a predefined maximum speed). Stated differently, the separation between the target's peak and minimum responses may be within predefined limits. In certain aspects, for targets moving at higher speeds (e.g., above a predefined threshold), the computing device 110 can apply the GMF to a decimated image(s) of the GMCI response. The decimated image may be generated based on downsampling the GMCI response 124. Alternatively, the input images 122 to the GMCI function may be decimated, and/or the GMCI integration interval may be reduced to decrease the separation between the peak and trough responses on the GMCI output image, F. Correspondingly, for targets below a given speed the GMCI integration interval may be increased to generate the requisite separation between the target peak and trough responses on the GMCI output image.

After approximating a matched filter, the computing device 110 (via the detection component 132) can apply the approximation to the GMCI output image(s) 124 to generate an enhanced image(s) 126. The computing device 110 (via the detection component 132) may perform target detection and tracking using the enhanced image(s) 126.

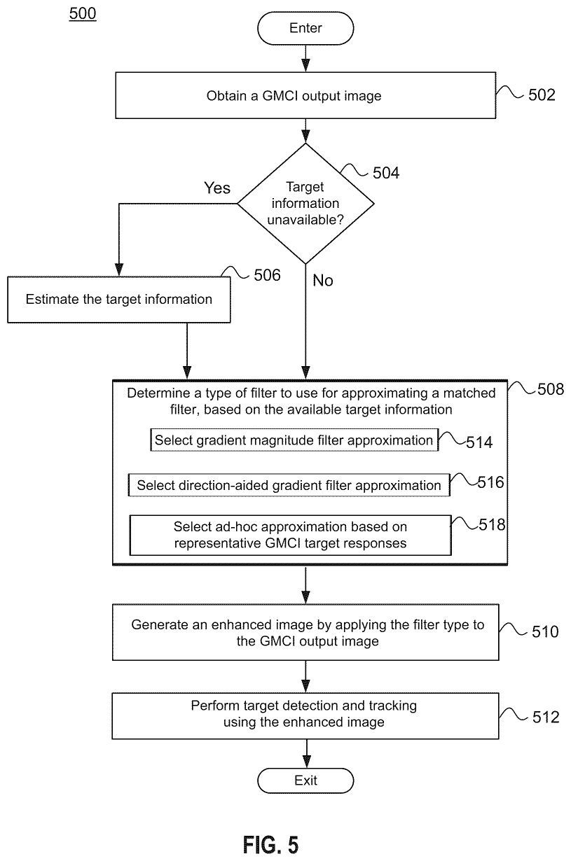

FIG. 5 is a flowchart of a method 500 for performing image-based target detection and tracking, according to certain aspects of the present disclosure. In certain aspects, the method 500 is performed to enhance detection of targets in motion-compensated integrated images, such as GMCI output images. Method 500 may be performed by a computing device, such as computing device 110.

Method 500 may enter at block 502, where the computing device obtains a GMCI output image (e.g., GMCI output image 124) of a target (e.g., target 130). In certain aspects, the computing device (or another computing device) may use a GMCI component (e.g., GMCI component 134) to generate the GMCI output image. For example, the GMCI component may map successive images of a moving target over a cluttered background to a pixel space in order to reduce the intensity of the background clutter relative to that of the target. The GMCI component may store the GMCI output images in a storage system (e.g., storage 116).

At block 504, the computing device determines whether at least some information associated with the target is unavailable. The target information (e.g., target information 128) may include one or more parameters of an image sensor (e.g., image sensor 120) used to capture an image of the target, a heading of the target, a speed of the target, or a combination thereof. The target's speed and heading may be referred to herein as the target's velocity. Target information may come from sources such as auxiliary sensors, third party sources, or prior iterations of the detection and tracking process.

If, at block 504, at least some of the target information is unavailable, the method 500 proceeds to block 506, where the computing device estimates the unavailable target information. For example, if no prior target information is known (e.g., the computing system is performing initial target acquisition) and if the target is moving within the appropriate speed range, then the computing system can use the local gradient to estimate the target heading, θ, according to Equation (9). On the other hand, if, at block 504, the target information is available (e.g., the target heading is known), then the method proceeds to block 508.

At block 508, the computing system determines a type of filter to use for approximating a matched filter, based at least in part on the available target information. The operations in block 508 may include instantiating the appropriate matched filter approximation based on the available target information. For example, when the target information (e.g., target heading) is known, the computing system may select and use a DAGF (e.g., Equation (8)) to approximate the matched filter (block 516). In another example, when at least some of the target information (e.g., target heading) is unavailable, the computing system may select and use a GMF (e.g., Equation (10)) to approximate the matched filter (block 514). In yet another example, when representative target responses in the GMCI output images are available or can be inferred from multiple GMCI output images, the computing system can construct an ad-hoc approximation to a matched filter, e.g., similar to the ad-hoc approximation used to construct the matched filter response 320 depicted in FIG. 3 (block 518).

At block 510, the computing system generates an enhanced image, based on applying the filter type to the GMCI output image. At block 512, the computing system performs target detection and tracking using the enhanced image. In certain aspects, the ability of the computing system to detect the target may be significantly enhanced with the enhanced image as compared to the GMCI output image. For example, the target's SNR (e.g., contrast ratio) in the enhanced image may be significantly higher than the target's SNR in the GMCI output image.

Advantageously, aspects described herein provide a matched filtering technique in which one or more approximations are applied to a GMCI output image to (i) enhance the target response within a series of images generated by the GMCI algorithm (and related overlap-and-add techniques), and (ii) reduce the effects of residual background clutter in the images. As such, aspects described herein provide a computationally efficient means of enhancing GMCI (and similarly generated) images by approximating a matched filter using available target information. This, in turn, enables improved target detection and tracking relative to standard detection and tracking techniques.

A further understanding of at least some of the aspects of the present disclosure is provided with reference to the following numbered Clauses, in which:

Clause 1: A computer-implemented method comprising: obtaining a geodetic motion-compensated integrated (GMCI) output image of a target; generating an approximation to a matched filter, based on information associated with the target; generating an enhanced image, based at least in part on the approximation and the GMCI output image; and detecting and tracking the target using the enhanced image.

Clause 2: The computer-implemented method of Clause 1, further comprising: prior to generating the approximation, determining that a portion of the information associated with the target is unavailable; and in response to the determination, generating an estimate of the portion of the information associated with the target.

Clause 3: The computer-implemented method of Clause 2, wherein the portion of the information associated with the target comprises a heading of the target.

Clause 4: The computer-implemented method of Clause 3, wherein the heading of the target is estimated based on a first gradient of the GMCI output image along a first direction and a second gradient of the GMCI output image along a second direction.

Clause 5: The computer-implemented method of Clause 1, wherein the approximation comprises a direction aided gradient filter (DAGF).

Clause 6: The computer-implemented method of any of Clauses 1 to 4, wherein the approximation comprises a gradient magnitude filter (GMF).

Clause 7: The computer-implemented method of any of Clauses 1 to 6, wherein generating the enhanced image comprises applying the approximation to the GMCI output image when the information associated with the target satisfies a set of predetermined conditions.

Clause 8: The computer-implemented method of any of Clauses 1 to 6, wherein generating the enhanced image comprises: generating a decimated GMCI image based on the GMCI output image, when the information associated with the target does not satisfy a set of predetermined conditions; and applying the approximation to the decimated GMCI image.

Clause 9: The computer-implemented method of Clause 8, wherein the set of predetermined conditions comprises a speed of the target being within predefined limits.

Clause 10: The computer-implemented method of any of Clauses 1 to 9, wherein a signal-to-noise ratio (SNR) of the target in the enhanced image is greater than a SNR of the target in the GMCI output image.

Clause 11: The computer-implemented method of any of Clauses 1 to 10, wherein the information associated with the target comprises at least one of a heading of the target or a speed of the target.

Clause: 12: A system comprising: a memory comprising executable instructions; and a processor in data communication with the memory and configured to execute the executable instructions to perform an operation comprising: obtaining a geodetic motion-compensated integrated (GMCI) output image of a target; generating an approximation to a matched filter, based on information associated with the target; generating an enhanced image, based at least in part on the approximation and the GMCI output image; and detecting and tracking the target using the enhanced image.

Clause 13: The system of Clause 12, the operation further comprising: prior to generating the approximation, determining that a portion of the information associated with the target is unavailable; and in response to the determination, generating an estimate of the portion of the information associated with the target.

Clause 14: The system of Clause 13, wherein the portion of the information associated with the target comprises a heading of the target.

Clause 15: The system of Clause 14, wherein the heading of the target is estimated based on a first gradient of the GMCI output image along a first direction and a second gradient of the GMCI output image along a second direction.

Clause 16: The system of Clause 12, wherein the approximation comprises a direction aided gradient filter (DAGF).

Clause 17: The system of any of Clauses 12 to 15, wherein the approximation comprises a gradient magnitude filter (GMF).

Clause 18: The system of any of Clauses 12 to 17, wherein generating the enhanced image comprises applying the approximation to the GMCI output image when the information associated with the target satisfies a set of predetermined conditions.

Clause 19: The system of any of Clauses 12 to 17, wherein generating the enhanced image comprises: generating a decimated GMCI image based on the GMCI output image, when the information associated with the target does not satisfy a set of predetermined conditions; and applying the approximation to the decimated GMCI image.

Clause 20: A computer-readable storage medium having computer-readable program code embodied therewith for performing an operation comprising: obtaining a geodetic motion-compensated integrated (GMCI) output image of a target; generating an approximation to a matched filter, based on information associated with the target; generating an enhanced image, based at least in part on the approximation and the GMCI output image; and detecting and tracking the target using the enhanced image.

Clause 21: A computer-readable storage medium having computer-readable program code embodied therewith for performing the computer-implemented method of any of Clauses 1 to 11.

In the current disclosure, reference is made to various aspects. However, it should be understood that the present disclosure is not limited to specific described aspects. Instead, any combination of the following features and elements, whether related to different aspects or not, is contemplated to implement and practice the teachings provided herein. Additionally, when elements of the aspects are described in the form of “at least one of A or B,” it will be understood that aspects including element A exclusively, including element B exclusively, and including element A and B are each contemplated. Furthermore, although some aspects may achieve advantages over other possible solutions and/or over the prior art, whether or not a particular advantage is achieved by a given aspect is not limiting of the present disclosure. Thus, the aspects, features, aspects and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects described herein may be embodied as a system, method or computer program product. Accordingly, aspects may take the form of an entirely hardware aspect, an entirely software aspect (including firmware, resident software, micro-code, etc.) or an aspect combining software and hardware aspects that may all generally be referred to herein as a “circuit,” “module” or “system.” Furthermore, aspects described herein may take the form of a computer program product embodied in one or more computer readable storage medium(s) having computer readable program code embodied thereon.

Program code embodied on a computer readable storage medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to aspects of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various aspects of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While the foregoing is directed to aspects of the present disclosure, other and further aspects of the disclosure may be devised without departing from the basic scope thereof, and the scope thereof is determined by the claims that follow.

What is claimed is:

1. A computer-implemented method comprising:
obtaining a geodetic motion-compensated integrated (GMCI) output image of a target;
generating an approximation to a matched filter, based on information associated with the target;
generating an enhanced image, based at least in part on the approximation and the GMCI output image; and
detecting and tracking the target using the enhanced image.

2. The computer-implemented method of claim 1, further comprising:
prior to generating the approximation, determining that a portion of the information associated with the target is unavailable; and
in response to the determination, generating an estimate of the portion of the information associated with the target.

3. The computer-implemented method of claim 2, wherein the portion of the information associated with the target comprises a heading of the target.

4. The computer-implemented method of claim 3, wherein the heading of the target is estimated based on a first gradient of the GMCI output image along a first direction and a second gradient of the GMCI output image along a second direction.

5. The computer-implemented method of claim 1, wherein the approximation comprises a direction aided gradient filter (DAGF).

6. The computer-implemented method of claim 1, wherein the approximation comprises a gradient magnitude filter (GMF).

7. The computer-implemented method of claim 1, wherein generating the enhanced image comprises applying the approximation to the GMCI output image when the information associated with the target satisfies a set of predetermined conditions.

8. The computer-implemented method of claim 1, wherein generating the enhanced image comprises:
generating a decimated GMCI image based on the GMCI output image, when the information associated with the target does not satisfy a set of predetermined conditions; and
applying the approximation to the decimated GMCI image.

9. The computer-implemented method of claim 8, wherein the set of predetermined conditions comprises a speed of the target being within predefined limits.

10. The computer-implemented method of claim 1, wherein a signal-to-noise ratio (SNR) of the target in the enhanced image is greater than a SNR of the target in the GMCI output image.

11. The computer-implemented method of claim 1, wherein the information associated with the target comprises at least one of a heading of the target or a speed of the target.

12. A system comprising:
a memory comprising executable instructions; and
a processor in data communication with the memory and configured to execute the executable instructions to perform an operation comprising:
obtaining a geodetic motion-compensated integrated (GMCI) output image of a target;
generating an approximation to a matched filter, based on information associated with the target;
generating an enhanced image, based at least in part on the approximation and the GMCI output image; and
detecting and tracking the target using the enhanced image.

13. The system of claim 12, the operation further comprising:
prior to generating the approximation, determining that a portion of the information associated with the target is unavailable; and
in response to the determination, generating an estimate of the portion of the information associated with the target.

14. The system of claim 13, wherein the portion of the information associated with the target comprises a heading of the target.

15. The system of claim 14, wherein the heading of the target is estimated based on a first gradient of the GMCI output image along a first direction and a second gradient of the GMCI output image along a second direction.

16. The system of claim 12, wherein the approximation comprises a direction aided gradient filter (DAGF).

17. The system of claim 12, wherein the approximation comprises a gradient magnitude filter (GMF).

18. The system of claim 12, wherein generating the enhanced image comprises applying the approximation to the GMCI output image when the information associated with the target satisfies a set of predetermined conditions.

19. The system of claim 12, wherein generating the enhanced image comprises:
generating a decimated GMCI image based on the GMCI output image, when the information associated with the target does not satisfy a set of predetermined conditions; and
applying the approximation to the decimated GMCI image.

20. A computer-readable storage medium having computer-readable program code embodied therewith for performing an operation comprising:
obtaining a geodetic motion-compensated integrated (GMCI) output image of a target;
generating an approximation to a matched filter, based on information associated with the target;
generating an enhanced image, based at least in part on the approximation and the GMCI output image; and
detecting and tracking the target using the enhanced image.
